(19) United States
(12) Patent Application Publication
(10) Pub. No.: US 2015/0193873 A1
(43) Pub. Date: Jul. 9, 2015

(54) SYSTEMS AND METHODS FOR DYNAMIC, RISK-BASED PURCHASE FINANCING

(71) Applicant: Capital One Financial Corporation, McLean, VA (US)

(72) Inventors: Luke A. HAMMOCK, Washington, DC (US); Lawrence DOUGLAS, McLean, VA (US)

(73) Assignee: CAPITAL ONE FINANCIAL CORPORATION, McLean, VA (US)

(21) Appl. No.: 14/592,317

(22) Filed: Jan. 8, 2015

Related U.S. Application Data
(60) Provisional application No. 61/925,300, filed on Jan. 9, 2014.

(51) Int. Cl. G06Q 40/02; G06Q 20/24; G06Q 20/40

(52) U.S. Cl. CPC G06Q 40/025; G06Q 20/24; G06Q 20/403

(57) ABSTRACT

This disclosure relates generally to credit-based transactions, and more particularly to dynamic purchase financing methods and systems. In one embodiment, a computer-implemented method provides a conditional credit line. The method receives a payment authorization request, and parses, via a processor, the payment authorization request to extract payment information. The method determines that the payment information includes information related to an extra credit line. The method generates, via the processor, a credit-risk allocation notification associated with the extra credit line, and transmits the credit-risk allocation notification to a computer associated with a financial institution.

### PRIORITY CLAIM

This U.S. patent application claims priority under 35 U.S.C. §119 to: U.S. Provisional Patent Application No. 61/925,300, titled “RISK-BASED INTERCHANGE PRICING METHODS AND SYSTEMS,” filed Jan. 9, 2014. The aforementioned application is incorporated herein by reference in its entirety for all purposes.

### TECHNICAL FIELD

This disclosure relates generally to credit-based transactions, and more particularly systems and methods for dynamic risk-based purchase financing.

### BACKGROUND

Issuers of credit cards can provide lines of credit under their own brand names on a seller-, seller-, or retailer-agnostic basis, and can also incentivize the use of credit cards. For example, issuers can offer deals (e.g., a discount off a purchase) connected to specific sellers (e.g., a seller or retailer). Various fees are often involved when credit cards are used in purchases. For example, payment networks charge the sellers fees when the payment networks are used to process credit-card transactions for customer purchases. For customers who are credit-constrained (e.g., lack sufficient issuer-provided credit to cover a purchase) and desire to make expensive purchases, sellers may finance such purchases on their own (e.g., through store credit cards). Customers, however, may find it embarrassing to request seller-provided financing in the store, and may perceive seller-provided financing as negatively affecting their credit scores. Sellers, on the other hand, may not want to bear all of the risks associated with financing the purchases on their own. They also may not want to bear the administrative costs of managing a store credit card program or other financing program. Therefore, there is a need for improved systems and methods that overcome these drawbacks.

### SUMMARY

Consistent with a disclosed embodiment, a computer-implemented method provides a conditional credit line. The method receives a payment authorization request, and parses, via a processor, the payment authorization request to extract payment information. The method determines that the payment information includes information related to an extra credit line. The method generates, via the processor, a credit-risk allocation notification associated with the extra credit line, and transmits the credit-risk allocation notification to a computer associated with a financial institution.

Consistent with another disclosed embodiment, a system is provided. The system includes a processor and a memory device. The memory device stores instructions that are executable by the processor. When the instructions are executed, the processor receives a payment authorization request, and parses the payment authorization request to extract payment information. The processor determines that the payment information includes information related to an extra credit line. The processor generates a credit-risk allocation notification associated with the extra credit line, and transmits the generated credit-risk allocation notification to a computer associated with a financial institution.

Consistent with another disclosed embodiment, a non-transitory computer-readable storage medium may store program instructions, which can be executed by a processor and perform any of the methods described herein.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an example of a dynamic purchase financing system;

FIG. 2 illustrates an example of a computer for implementing aspects of a real-time, dynamic purchase financing system;

FIGS. 3A, 3B, and 3C are schematic illustrations of an example of a dynamic purchase financing process;

FIG. 4 is a flowchart of an example of a payment initiation process;

FIG. 5 is a flowchart of an example of a conditional credit initiation process;

FIGS. 6A, 6B, and 6C are flowcharts of an example of a conditional credit offering process; and

FIG. 7 is a flowchart of an example of a credit-risk allocation process.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding blocks to the disclosed methods. Accordingly, the following detailed description is not limiting of the disclosed embodiments. Instead, the proper scope is defined by the appended claims.

Generally, disclosed embodiments are directed to systems and methods for providing customers with an extended line of credit, e.g., in real-time, when their existing funds are insufficient to make a purchase. Further, some sellers may find it difficult to manage store card programs, and would like instead to allow customers to extend their existing lines of credit rather than undertake the administrative burden of managing store card programs. Disclosed embodiments provide extended lines of customer credit for such sellers, while allowing the sellers to market such lines of credit as though they were store cards in their own brand names. Additionally, disclosed embodiments allocate risks associated with extending these credit lines among one or more parties, such as issuers, acquirers, payment networks, other financial institutions, etc.

Various embodiments are disclosed that describe financing a customer's purchase from a retail seller. It is to be understood, however, that the disclosed embodiments are not limited to retail customer purchases. Instead, the disclosed embodiments may be applied to the purchase, auctioning, renting, leasing, etc. of any item, product, or service, in any context (not only retail, but wholesale, distribution, exchange markets, etc.) and by any kind of entity (not only customers, but supply chain members, retailers, product manufacturers, investors, private equity, etc.).

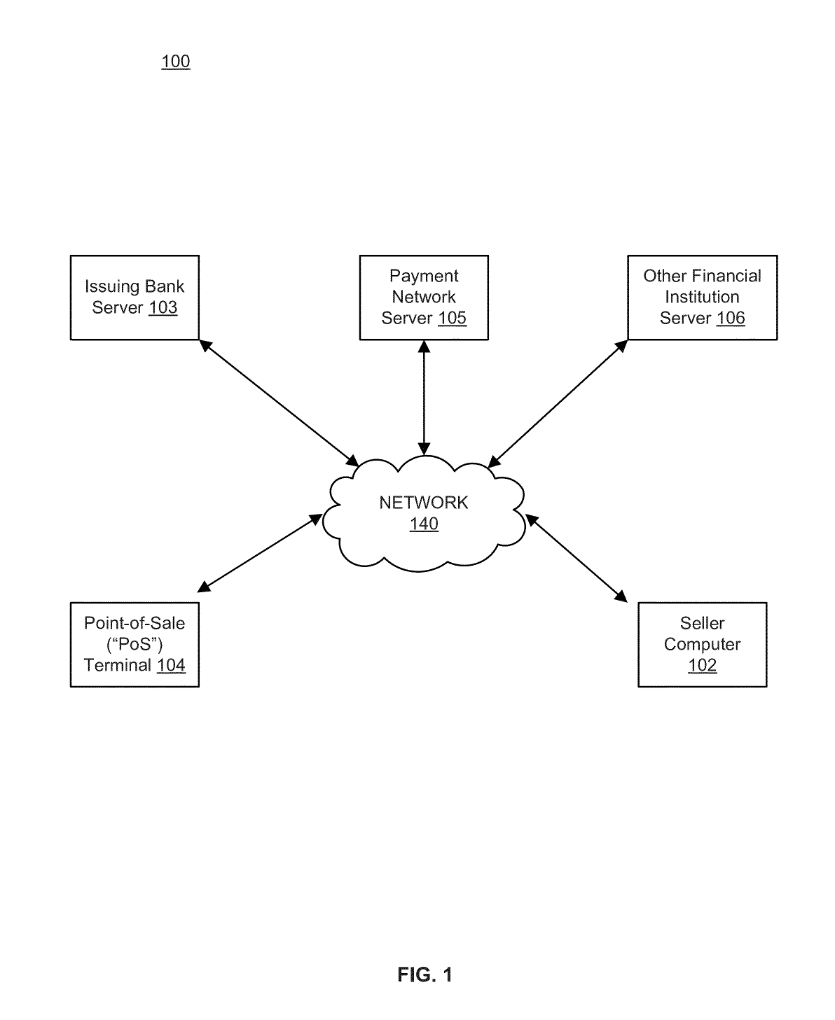

FIG. 1 illustrates an example of a dynamic purchase financing system 100. The features and other aspects and principles of the disclosed embodiments may be implemented in various environments. Such environments and related applications may be specifically constructed for performing the various processes and operations of the disclosed embodiments or they may include a computing platforms selectively activated or reconfigured by program code to provide the necessary functionality. The processes disclosed herein may be implemented by a suitable combination of hardware, software, and/or firmware. For example, the disclosed embodiments may implement computing platforms that may be configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by computing platforms as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

As shown in FIG. 1, system 100 includes an issuing bank server 103, a payment network server 105, other financial institution server 106, as well as a point-of-sale (“PoS”) terminal 104 and a seller computer 102. Issuing bank server 103, payment network server 105, and other financial institution server 106 may be part of various financial service providers, such as issuers, acquirers, payment processors, lenders, banks, private equity firms, hedge firms, etc. Financial service providers may include entities that configure, offer, provide, and/or manage financial service accounts, such as credit card accounts, debit card accounts, checking or savings accounts, loyalty accounts, and/or loan accounts, or facilitate transactions involving such financial service accounts. Financial service providers may configure one or more financial service accounts for customers such as a user operating PoS terminal 104.

Examples of such accounts include, without limitation, credit card accounts, debit card accounts, checking or savings accounts, and loan accounts. For example, an issuing bank may provide a credit account for financing a purchase to one or more customers operating PoS terminal 104. In some embodiments, the credit account may be a credit card. In some embodiments, a payment processor, or payment network provider, may receive and process payments from customers (via, e.g., PoS terminal 104) relating to the financial service accounts. Issuing bank server 103, payment network server 105, other financial institution server 106, PoS terminal 104, and seller computer 102 may be configured to transmit financial information (e.g., related to one or more customers operating PoS terminal 104) via a network 140 to the other components in communication with network 140.

Issuing bank server 103, payment network server 105, other financial institution server 106, PoS terminal 104, and seller computer 102 may include one or more computers (e.g., servers, database systems, etc.) configured to execute software instructions programmed to perform aspects of the disclosed embodiments, such as generating financial service accounts, maintaining accounts, processing information relating to accounts, etc. Consistent with disclosed embodiments, each component may include other sub-components and infrastructure that enable it to perform operations, processes, and services consistent with financial service account providers, such as banking operations, credit card operations, loan operations, etc.

PoS terminal 104 may represent a device associated with an entity seeking to purchase an item from another party. Although the following description of disclosed embodiments may refer to an “individual,” it is to be understood that the same description applies to multiple customers acting in concert or to a customer entity in the manner described above. PoS terminal 104 may include one or more components that perform processes consistent with the disclosed embodiments. For example, PoS terminal 104 may be of the form of a computer including a processor that is configured to execute software instructions programmed to perform aspects of the disclosed embodiments, stored in memory. For example, PoS terminal 104 may comprise a mobile device, such as a smartphone or a tablet. In other implementations, PoS terminal 104 may comprise a laptop or desktop computer. One of ordinary skill in the art would recognize that PoS terminal 104 may include components and infrastructure that enable it to perform operations, processes, and services such as processing sales transactions of purchases made over the Internet or at POS locations, and communicating with the other components connected to network 140. PoS terminal 104 may be configured to purchase an item, transmit and receive information associated with the purchase transaction, and process and monitor a loan account associated with financing the purchase transaction. PoS terminal 104 may be owned or operated by a customer (e.g., a mobile phone, smartphone, tablet, laptop computer, etc.), or it may be owned or operated by a seller (e.g., a checkout terminal at a retail store).

Seller computer 102 may represent one or more devices configured to receive, process, display, and transmit information associated with items for purchase. Although the following description of certain embodiments may refer to an “individual” computer, one skilled in the art would appreciate that the same description applies to multiple computers acting in concert or to a corporate entity in the manner described above. In the retail example, in some embodiments, seller computer 102 may be configured to access common inventory databases (not shown) that contain information relating to items for retail purchase. Seller computer 102 may be owned by the same entity or different entities. Seller computer 102 may include components and infrastructure that enable it to perform operations, processes, and services consistent with sellers, such as providing websites that offer for sale goods and/or services, processing sales transactions of purchases, and communicating with financial service system 110 or other components relating to the transactions.

Consistent with disclosed embodiments, the above-described devices may include one or more hardware processors. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable execution of multiple processes simultaneously. Other types of processor arrangements could be implemented that provide for the capabilities disclosed herein. Moreover, the processors may represent one or more servers or other computing devices that are associated with the above-described devices. For instance, the processors may represent a distributed network of processors configured to operate together over a local or wide area network. Alternatively, the processors may be a processing device configured to execute software instructions that receive and send information, instructions, etc. to/from other processing devices or components. In certain aspects, the processors may be configured to execute software instructions stored in memory to perform one or more processes consistent with disclosed embodiments.

Consistent with disclosed embodiments, components of the system including PoS terminal 104, issuing bank server 103, seller computer 102, payment network server 105, other financial institution server 106, may also include one or more memory devices. The memory devices may store software instructions that are executed by processors, such as one or more applications, network communication processes, operating system software, software instructions relating to the disclosed embodiments, and any other type of application or software known to be executable by processing devices. The memory devices may be a volatile or non-volatile, magnetic, semiconductor, tape, optical, removable, non-removable, or other type of storage device or non-transitory computer-readable medium. The memory devices may be two or more memory devices distributed over a local or wide area network, or may be a single memory device. In certain embodiments, the memory devices may include database systems, such as database storage devices, including one or more database processing devices configured to receive instructions to access, process, and send information stored in the storage devices. By way of example, database systems may including Oracle™ databases, Sybase™ databases, or other relational databases or non-relational databases, such as Hadoop sequence files, HBase, or Cassandra.

In some embodiments, PoS terminal 104, issuing bank server 103, seller computer 102, payment network server 105, and other financial institution server 106 may also include one or more additional components (not shown) that provide communications with other components, such as through network 140, or any other suitable communications infrastructure.

Network 140 may be any type of network that facilitates communications and data transfer between components of the system environment, such as, for example, PoS terminal 104, issuing bank server 103, seller computer 102, payment network server 105, and other financial institution server 106. Network 140 may be a Local Area Network (LAN), a Wide Area Network (WAN), such as the Internet, and may be a single network or a combination of networks. Further, network 140 may include a single type of network or a combination of different types of networks, such as the Internet and public exchange networks for wire-line and/or wireless communications. Network 140 may use cloud-computing technologies that are familiar in the marketplace. Moreover, any part of network 140 may be implemented through traditional infrastructures or channels of trade, to permit operations associated with financial accounts that are performed manually or in-person by the various entities illustrated in FIG. 1. Network 140 is not limited to the above examples and the system may implement any type of network that allows the entities (and others not shown) included in FIG. 1 to exchange data and information.

Although FIG. 1 describes a certain number of entities and processing/computing components within the system environment, any number or combination of components may be implemented without departing from the scope of the disclosed embodiments. For example, seller computer 102 may interact with one or more PoS terminals 104 through network 140 or standard channels of trade, such as face-to-face purchase transactions or brick-and-mortar locations. In another example, issuing bank server 103, payment network server 105, and other financial institution server 106 may interact with one or more PoS terminals 104 and seller computers 102 through network 140 or standard channels of trade. Additionally, PoS terminal 104, issuing bank server 103, seller computer 102, payment network server 105, and other financial institution server 106 are not necessarily mutually exclusive, and each of these components may be part of the same entity or affiliated with the same entity. The entities as described are not limited to their discrete descriptions above. Further, where different components, the computing and processing devices and software executed by these components may be integrated into a local or distributed system.

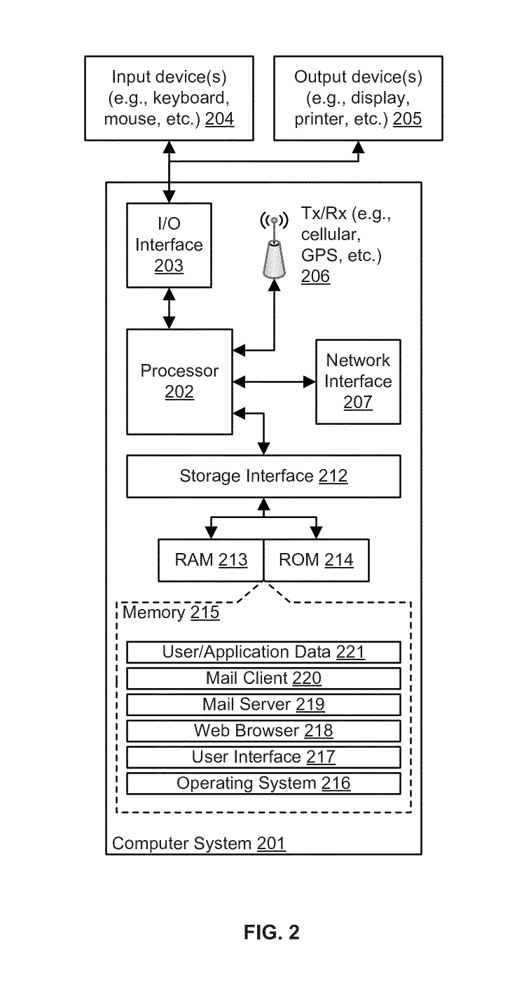

FIG. 2 is a block diagram of a computer 201 for implementing embodiments consistent with the present disclosure. Variations of computer 201 may be used to implement PoS terminal 104, issuing bank server 103, seller computer 102, payment network server 105, and other financial institution server 106 shown in FIG. 1.

Computer system 201 may comprise a central processing unit (“CPU” or “processor”) 202. Processor 202 may comprise at least one data processor for executing program components for executing user- or system-generated requests. A user may include a person, a person using a device such as those included in this disclosure, or such a device itself. Processor 202 may include specialized processing units such as integrated system (bus) controllers, memory management control units, floating point units, graphics processing units, digital signal processing units, etc. For example, processor 202 may include a microprocessor, such as AMD Athlon, Duron or Opteron, ARM's application, embedded or secure processors, IBM PowerPC, Intel's Core, Itanium, Xeon, Celeron or other line of processors, etc. Processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 202 may communicate with one or more input/output (I/O) devices via I/O interface 203. I/O interface 203 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 203, computer 201 may communicate with one or more I/O devices. For example, input device 204 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 205 may be a printer, fax machine, video display (e.g., cathode ray tube (CRT), liquid crystal display (LCD), light-emitting diode (LED), plasma, or the like), audio speaker, etc. In some embodiments, a transceiver 206 may be disposed in connection with processor 202. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 202 may communicate with a network (e.g., network 104) via a network interface 207. Network interface 207 may employ connection protocols including, for example, direct connect, Ethernet (e.g., twisted pair 10/100/1000 Base T), transmission control protocol/internet protocol (TCP/IP), token ring, IEEE 802.11a/b/g/n/x, etc. Using network interface 207, computer 201 may communicate with various devices (e.g., the components depicted in FIG. 1). These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer 201 may itself embody one or more of these devices.

Processor 202 may communicate with one or more memory devices 215 (e.g., RAM 213, ROM 214, etc.) via a storage interface 212. Storage interface 212 may connect to memory devices including, for example, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 215 may store a collection of program or database components, including, without limitation, an operating system 216, a user interface application 217, a web browser 218, a mail server 219, a mail client 220, user/application data 221 (e.g., any data variables or data records discussed in this disclosure), etc. For example, operating system 216 may facilitate resource management and operation of computer 201. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 217 may facilitate display, execution, interaction, manipulation, or operation of program components through textual or graphical facilities. For example, user interface 217 may provide computer interaction interface elements on a display system operatively connected to computer 201, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer 201 may implement web browser 218 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc.

Mail server 219 may be an Internet mail server such as Microsoft Exchange, or the like. Mail server 219 may use facilities such as ASP, ActiveX, ANSI C++/C#, Microsoft .NET, CGI scripts, Java, JavaScript, PERL, PHP, Python, WebObjects, etc. Mail server 219 may use communication protocols such as internet message access protocol (IMAP), messaging application programming interface (MAPI), Microsoft Exchange, post office protocol (POP), simple mail transfer protocol (SMTP), or the like. In some embodiments, computer system 201 may implement a mail client 220 stored program component. The mail client may be a mail viewing application, such as Apple Mail, Microsoft Entourage, Microsoft Outlook, Mozilla Thunderbird, etc.

User/application data 221 may be implemented as fault-tolerant, relational, scalable, secure databases such as Oracle or Sybase. Alternatively, such databases may be implemented using standardized data structures, such as an array, hash, linked list, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

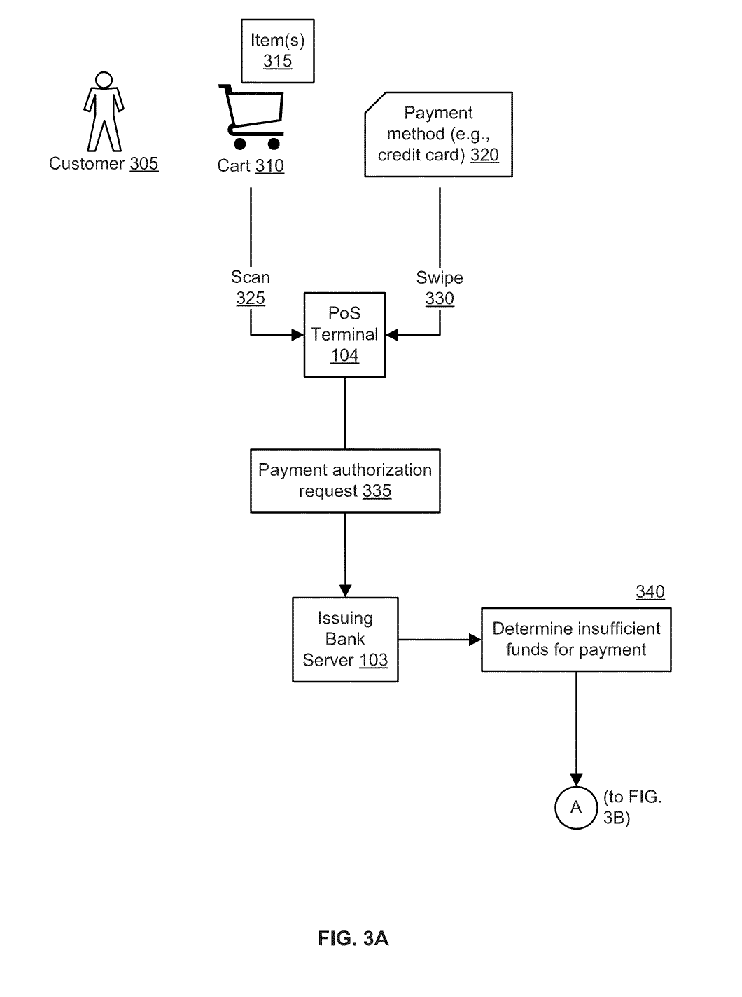

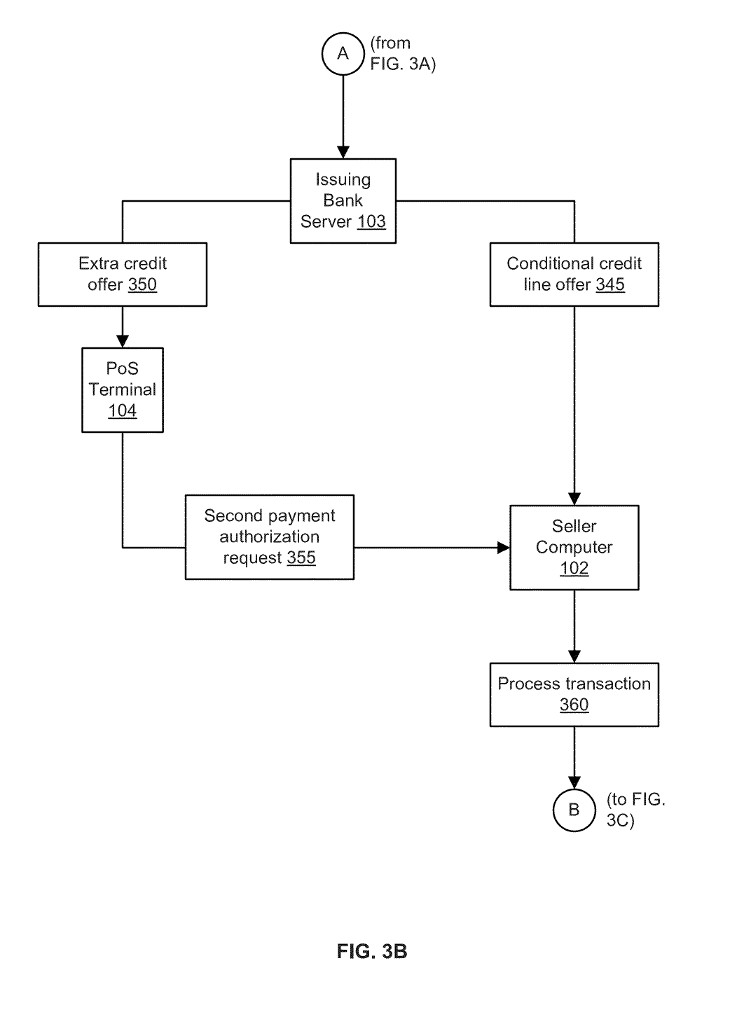

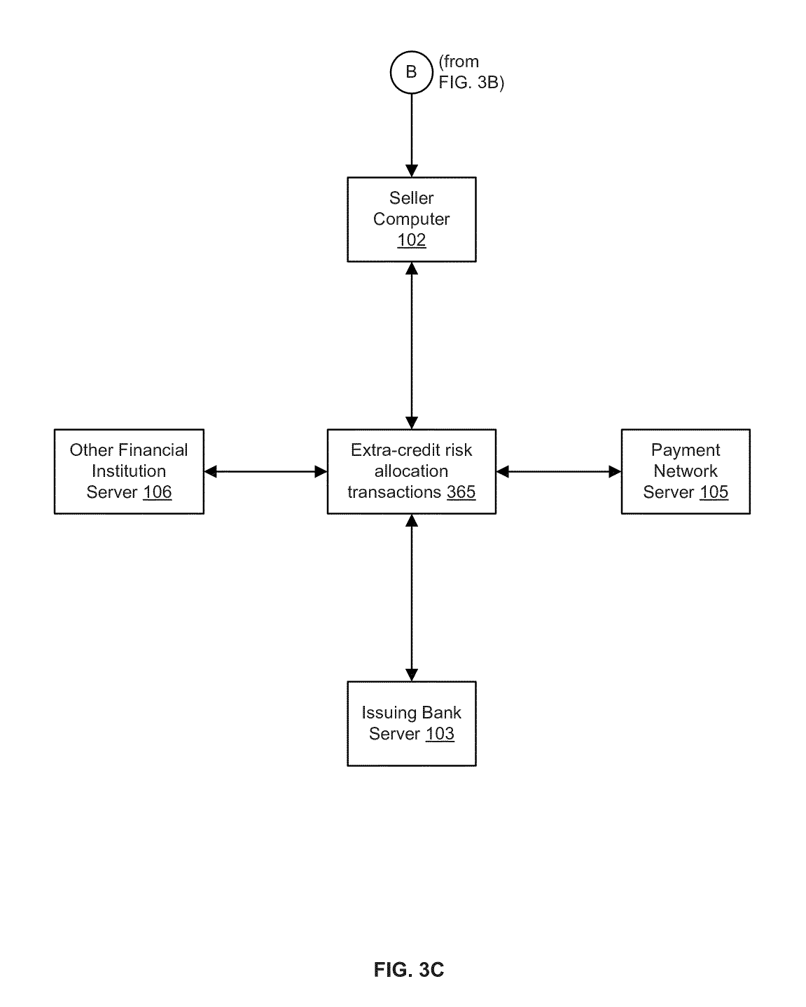

FIGS. 3A, 3B, and 3C provide an example of a real-time, dynamic purchase financing process. As shown in FIG. 3A, a customer 305 may desire to purchase item(s) 315 in the customer's (virtual/physical) shopping cart 310 at PoS terminal 104 from a seller operating seller computer 102. Customer 305 may use a payment method 320 (e.g., debit card, credit card, NFC/Bluetooth/RFID-enabled hardware, or electronically stored information) to provide payment information to PoS terminal 104. PoS terminal 104 may provide a payment authorization request 335 to an issuing bank server 103. In some embodiments, issuing bank server 103 may determine that payment method 320 is deficient (see 340), e.g., customer 305 does not have sufficient funds (e.g., account balance, credit, etc.) associated with payment method 320 to complete the purchase transaction. Accordingly, issuing bank server 103 may provide an insufficient funds notice to seller computer 102.

As shown in FIG. 3B, issuing bank server 103 may provide a conditional credit line offer 345 to the seller, extending an extra credit line to customer 305. Offer 345 may be conditioned upon the seller and/or other entities engaging in a risk allocation procedure. In such a risk allocation procedure, one or more participants may assume the risk associated with the transaction being fraudulent, or the risk of customer 305 defaulting on repayment of the extra credit line, according to an agreed-upon strategy. In some embodiments, the seller may be pre-approved with issuing bank server 103 for conditional credit line offer 345. In other embodiments, conditional credit line offer 345 need not be sent for approval to the seller because the seller already accepted (e.g., as a default position) to use conditional credit line offer 345 provided by issuing bank server 103.

Accordingly, issuing bank server 103 may provide in real-time an extra credit offer 350 for customer 305 via PoS terminal 104. For example, while customer 305 is in the store and operating a checkout procedure, PoS terminal 104 may provide a notification that payment method 320 has insufficient funds, but that an extra credit line is available to customer 305, in real-time. In some embodiments, the store may be able to market the extra credit line as an on-the-spot store credit card offered to customer 305. A second payment authorization request 355 may then be sent, and customer 305 may complete a customer order using the extra credit line, which may be provided to seller computer 102 for payment processing 360.

As shown in FIG. 3C, during payment processing, an entity, such as issuing bank server 103, may determine that the use of the extra credit line requires it to initiate a risk allocation procedure, including one or more extra credit-risk allocation transactions 365. Participants in extra credit-risk allocation transactions 365 may include PoS terminal 104, issuing bank server 103, seller computer 102, payment network server 105, and other financial institution server 106. The risk allocation procedure may be specified by a number of risk allocation rules stored in a database accessible to one or more of the entities shown in FIG. 1, such as issuing bank server 103.

In some embodiments, to complete the purchase, the customer may be required to accept a new annual percentage rate (APR) on their card. In some embodiments, the higher APR may only apply for the duration that the credit line exceeds the original limit. In other embodiments, the higher APR may only apply for the duration that the customer's extra credit line account has a balance remaining. In some embodiments, the item purchased might be used as collateral to secure the extra credit line. The decisions may be handled programmatically (e.g., part of the credit card authorization process), online application form, or by having a human call/communicate with the issuing bank. In some embodiments, the financing decision may be integrated into a mobile device or mobile application that would allow the customer to select from several financing options.

In some embodiments, issuer bank server 103 or another entity may initiate a real-time bidding (RTB) auction related to the issuance of extra credit line(s) (e.g., either for an individual extra credit line or for aggregated extra credit lines), thereby allowing for risk allocation across a wide market of participants. Further, any other financial institution or investment entity (such as investors or private equity funds) may agree to bear some risk of fraud or non-repayment by the customer in exchange for an up-front fee payment.

In some embodiments, the fee may be paid by an entity other than the seller. For example, the fee may be split with any of the other parties in the value chain (e.g., issuing bank, network, advertiser, seller acquiring bank, or seller). Alternatively, the issuer may pay the fee, rather than the seller. As another example, the financial institution or investment entity agreeing to bear some risk of fraud or non-repayment may agree to a negative fee payment, initially, in exchange for a greater share of proceeds from repayment by the customer. In other words, a reimbursement model and/or additional charge model may be combined in any fashion and applied to any of the entities discussed herein. In a reimbursement model, an entity may agree to a net negative initial fee payment in exchange for a higher reimbursement should the extra credit line perform well (e.g., the customer repays in full on time). In an additional charge model, an entity may agree to facilitate an extra line of credit, thus bearing additional risk, in exchange for assessing an additional charge should the extra credit line perform poorly (e.g., fraudulent transaction, or non-repayment by the customer).

In some embodiments, a real-time bidding (RTB) auction environment may be set up so that the individual or group of financial institutions or third parties might bid for the right to extend the additional financing if the issuing bank does not want to carry the debt.

In general, it is to be understood that all permutations and combination of risk allocation, and reward/punishment strategies, of which a few examples have been discussed above, may be applied to any and all entities discussed herein.

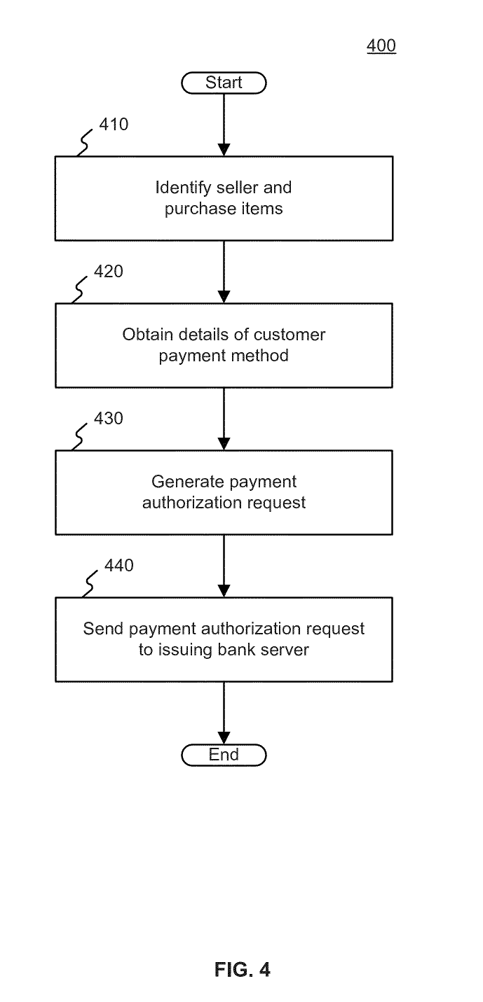

FIG. 4 is a flowchart of an example of a payment initiation process 400. In some embodiments, PoS terminal 104 may initiate a payment process to facilitate a purchase of item(s) 315, such as products or services, for customer 305.

At step 410, PoS terminal 104 may obtain an identification of a seller (e.g., stored in a database, or hard-coded into PoS terminal 104), as well as an identification of the item(s) 315 in cart 310 of customer 305. For example, PoS terminal 104 may be equipped with user input devices such as described above with reference to FIG. 2. As another example, PoS terminal 104 may be equipped with a barcode or QR code scanner, camera, etc.

At step 420, PoS terminal 104 may obtain the details of payment method 320 of customer 305, e.g., via a card swipe, RFID/NFC-enabled hardware, or from electronically stored credentials. For example, PoS terminal 104 may obtain Track 1 data from a credit card of customer 305.

Next, at step 430, using the obtained information, PoS terminal 104 may generate payment authorization request 335. For example, the payment authorization request may include, without limitation, a shopping session ID, customer ID, a PoS terminal device fingerprint, purchase amount, payment information such as an identification of the account from which funds are to be obtained to facilitate the purchase transaction, a seller ID, etc.

At step 440, PoS terminal 104 may send (e.g., as a HTTP POST message) the generated payment authorization request 335 to an issuing bank server 103, e.g., redirected/routed via seller computer 102, acquirer server (not shown), and payment network server 105.

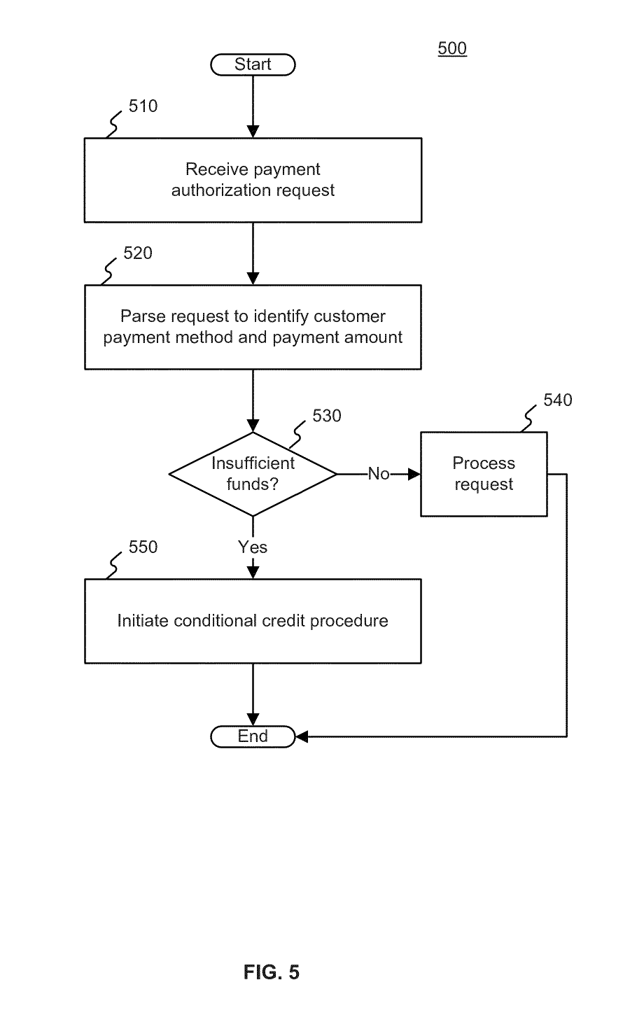

FIG. 5 is a flowchart of an example of a conditional credit initiation process 500. In some embodiments, issuing bank server 103 may initiate a conditional credit procedure to extend an extra credit line for customer 305.

At step 510, issuing bank server 103 may receive a payment authorization request 335 from, for example, PoS terminal 104. Payment authorization request 335 may be in the form of a HTTP POST message sent over network 140 (e.g., over the Internet).

At step 520, issuing bank server 103 may parse payment authorization request 335 to extract information such as, for example, customer payment credentials. For example, issuing bank server 103 may identify an account, such as a debit, credit, loan, checking, savings, etc., account, to use to fulfill the payment transaction for customer 305.

At decision 530, issuing bank server 103 may determine, using the extracted payment information, whether customer 305 has sufficient funds to cover the payment amount required for the purchase transaction. For example, issuing bank server 103 may perform a database lookup in an accounts database to obtain account information corresponding to the payment information provided in payment authorization request 335.

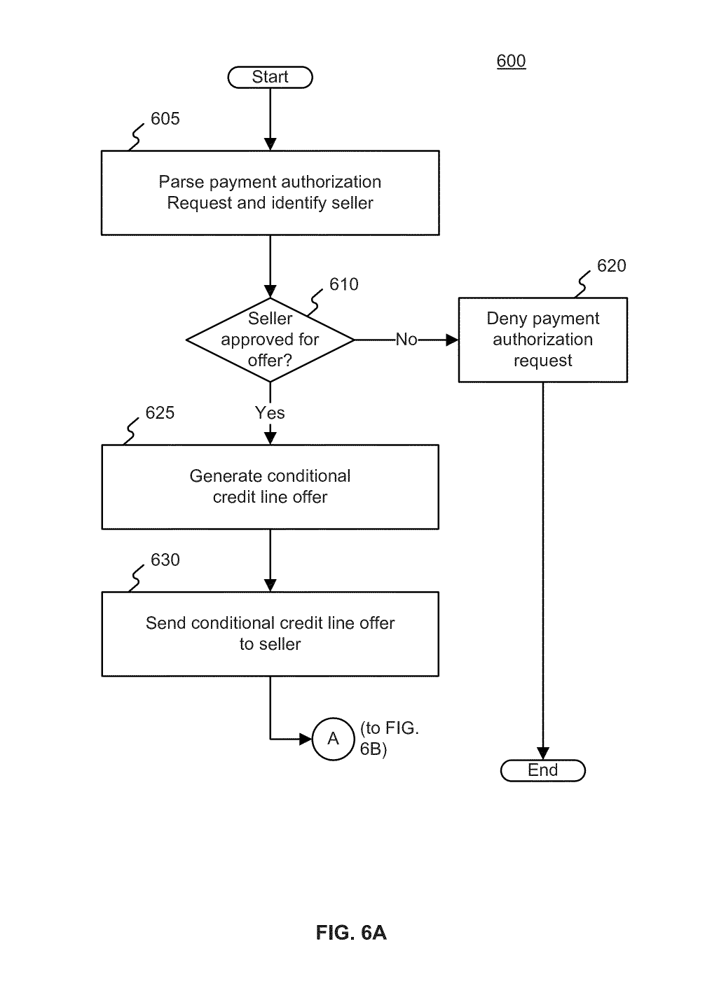

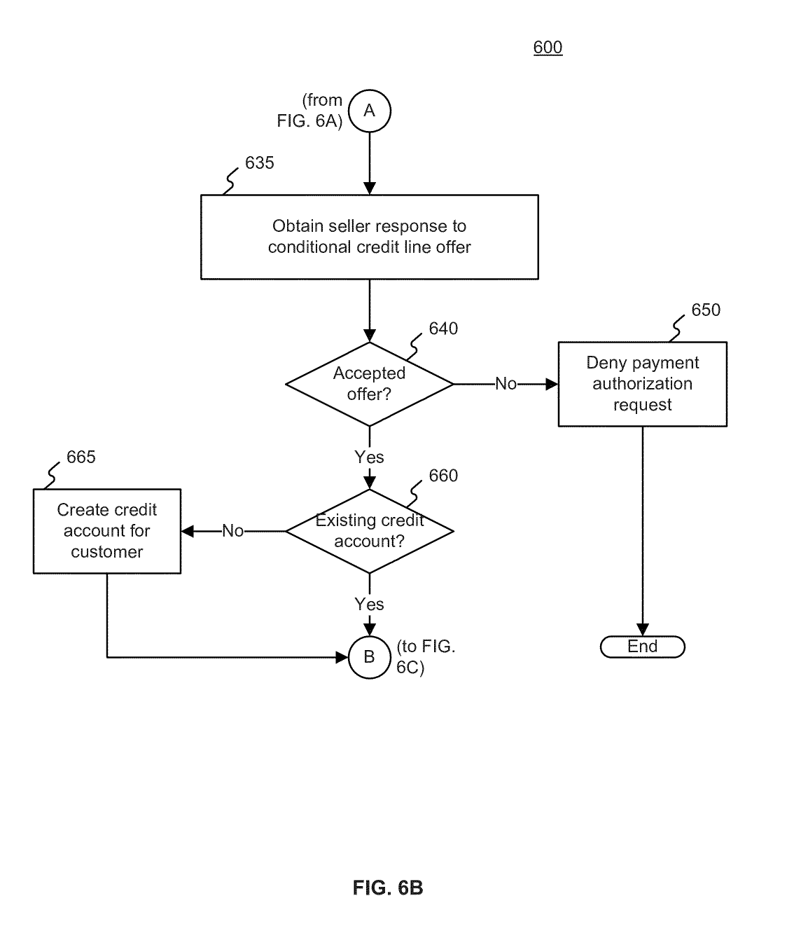

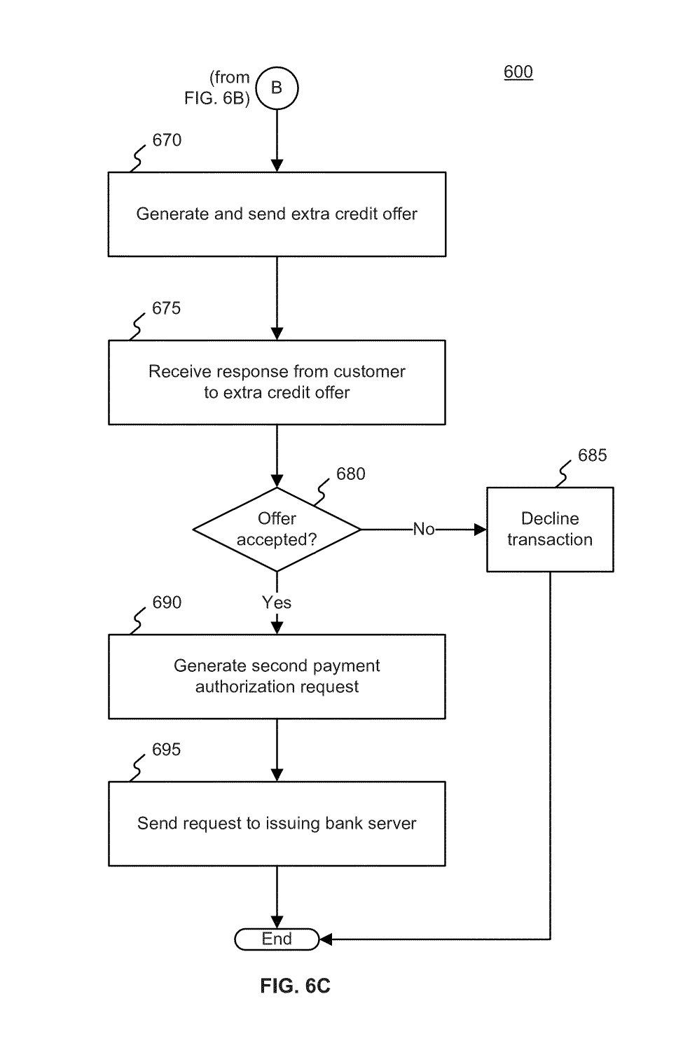

If customer 305 has sufficient funds, issuing bank server 103 may continue processing payment authorization request 335 in a traditional manner, as known to one of ordinary skill in the art, for the type of payment credentials (step 540). If, however, issuing bank server 103 determines that there are insufficient funds to continue the payment transaction in the traditional manner, issuing bank server 103 may initiate a conditional credit procedure (step 550). For example, issuing bank server 103 may implement a procedure similar to that described below with reference to FIGS. 6A, 6B, and 6C.

FIGS. 6A, 6B, and 6C are flowcharts of an example of a conditional credit offering process 600. As shown in FIG. 6A, where a conditional credit procedure is to be undertaken, at step 605, issuing bank server 103 may parse purchase authorization request 335 obtained from a PoS terminal 104, and may identify a seller associated with payment authorization request 335. In alternate embodiments, issuing bank server 103 may send a request (e.g., using a HTTP GET request) for the identification of the seller to PoS terminal 104.

At decision 610, issuing bank server 103 may determine whether the seller is approved to provide conditional credit line offers. For example, the issuing bank may have negotiated an agreement with the seller, and data concerning the agreement may be stored in a database, e.g., in the form of rules specifying a procedure for determining whether conditional credit line offering should be pursued. Issuing bank server 103 may query the database for the rules and/or agreement data, and make a determination on whether conditional credit line offer is approved for the seller.

If issuing bank server 103 determines the seller is not approved, issuing bank server 103 may send an authorization denial message to PoS terminal 104 (step 620), and payment processing may terminate. If the seller is approved, at step 625, issuing bank server 103 may generate a conditional credit line offer 345 based on, for example, a pre-agreement with the seller, customer, payment network, acquirer, or other financial institution.

In some embodiments, issuing bank server 103 may use profile data of customer 305 to generate conditional credit line offer 345. Profile data of customer 305 may be obtained by a side-channel communication with PoS terminal 104, or from payment authorization request 335. The profile data may include the customer's prior repayment history, credit profile, prior repayment history on prior extra credit lines given for purchases made with the instant seller, prior performance of the seller with regard to issuances of extra credit lines (to this or other customers in terms of payment of any fees), etc.

At step 630, issuing bank server 103 may send (e.g., via a HTTP POST message) the generated conditional credit line offer to seller computer 102. The conditional credit line offer may specify offer criteria such as offer expiry date and time, a customer identifier, a seller identifier, or the like.

As shown in FIG. 6B, process 600 continues and, at step 635, issuing bank server 103 may obtain a response to conditional credit line offer 345 from seller computer 102. At decision 640, issuing bank server 103 may parse the response to determine whether the seller accepted conditional credit line offer 345.

If the seller did not accept conditional credit line offer 345, issuing bank server 103 may send an authorization denial message to PoS terminal 104 (step 650). If the seller accepted conditional credit line offer 345, issuing bank server 103 may attempt to generate an extra credit line offer 350 for customer 305 (step 655). For example, issuing bank server 103 may determine whether customer 305 has an existing credit account with the issuing bank associated with issuing bank server 103. To do so, issuing bank server 103 may query an accounts database using data regarding customer 305 obtained, e.g., from payment authorization request 335, from a side-channel communication with PoS terminal 104, etc., for any credit-based accounts of customer 305.

At decision 660, issuing bank server 103 may determine whether customer 305 has an existing credit-based account with the issuing bank. If customer 305 does not have an existing credit-based account with the issuing bank, issuing bank server 103 may generate a (e.g., provisional, temporary, limited, etc.) credit account for customer 305 (step 665). If customer 305 already has an existing credit-based account with the issuing bank, the process proceeds to step 760, as shown in FIG. 6C.

As shown in FIG. 6C, at step 670, issuing bank server 103 may generate and send (e.g., via a HTTP GET message) extra credit line offer 350 to PoS terminal 104. In some embodiments, the size or amount of the extra credit line may depend on the excess credit that the customer 305 requires to complete a currently pending purchase transaction. Thus, issuing bank server 103 may, substantially in real-time, determine the amount of the extra credit line required, and generate extra credit offer 350 accordingly.

Next, in step 675, PoS terminal 104 may obtain an input from customer 305 in response to extra credit offer 350 provided by issuing bank server 103. At decision 680, if customer 305 does not accept extra credit offer 350, PoS terminal 104 may decline the transaction (step 685), and the purchase transaction may end. If customer 305 accepts extra credit offer 350, at step 690, PoS terminal 104 may generate a second payment authorization request using the information received from issuing bank server 103 regarding the extra credit offer 350. At step 695, PoS terminal 104 may send (e.g., as a HTTP POST message) the second generated payment authorization request that uses extra credit offer 350 to issuing bank server 103.

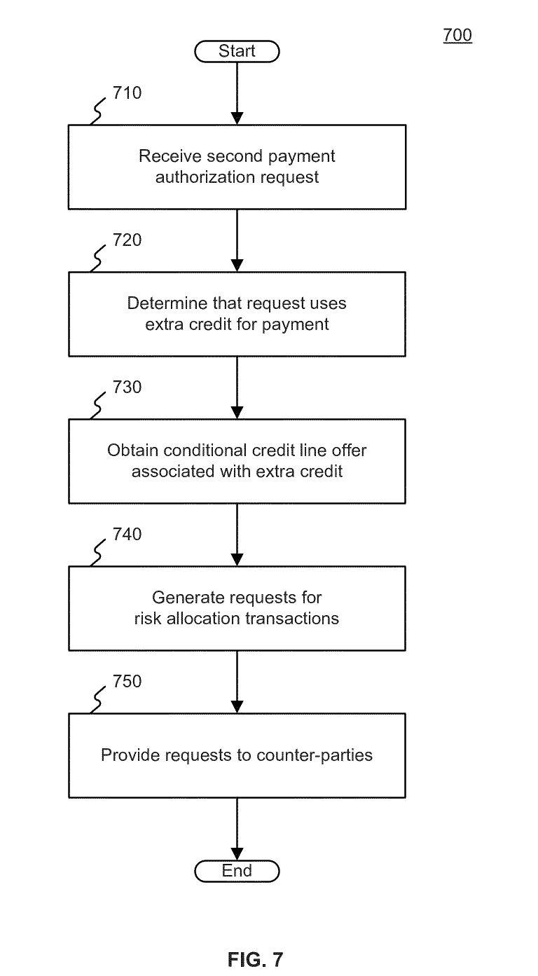

Issuing bank server 103, seller computer 102, payment network server 105, and other financial institution server 106 may communicate with each other to determine how to allocate risks, revenues, and/or profits associated with the extra credit extended to customer 305. For example, the computers may utilize database rules specifying a risk allocation procedure related to the customer's use of the extra credit line. Examples of such rules are described above with reference to FIG. 3C. FIG. 7 provides an example credit-risk allocation process 700 based on such database rules.

FIG. 7 is a flowchart of a credit-risk allocation process 700. When customer 305 uses extra credit offer 350 to purchase an item from a seller, issuing bank server 103 may initiate credit-risk allocation process 700. In credit-risk allocation process 700, the customer fraud or default risks may be allocated among one or more entities, such as an issuing bank, a payment network, the seller, or another financial institution.

At step 710, issuing bank server 103 may receive the second generated payment authorization request that uses extra credit offer 350 for payment information. At step 720, issuing bank server 103 may parse the request, and identify that the request uses extra credit offer 350 for payment. For example, in some embodiments, whenever issuing bank server 103 receives a payment authorization request, issuing bank server 103 may query an accounts database using the payment information, to determine whether the payment information reflects the use, at least in part, of extra credit offer 350 for payment.

Next, at step 730, issuing bank server 103 may obtain conditional credit line offer 345 made to the seller associated with extra credit line offer 350 that customer 305 used in the second payment authorization request. For example, issuing bank server 103 may query the accounts database for the negotiated agreement with the seller, and/or any data concerning the agreement that may be stored in the database. In some embodiments, issuing bank server 103 may retrieve from the database rules specifying a risk allocation procedure related to the customer's use of the extra credit line. Examples of such rules are described above with reference to FIG. 3C.

In step 740, issuing bank server 103 may generate requests for risk allocation transactions. Such transaction may include a payment from one entity to another, such as between the seller, issuing bank, payment network, and other financial institutions. In step 750, issuing bank server 103 may send the notice(s) or transaction request(s) according to the risk allocation rules. For example, issuing bank server 103 may send one or more HTTP POST messages including details of payments to be made from one entity to another, along with requests that the payments be authorized by the appropriate entities. As another example, issuing bank server 103 may provide notices of future payments that should be made if the customer fails to properly repay the extra credit used by the customer.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. For example, the described implementations include software, but systems and methods consistent with the disclosed embodiments be implemented as a combination of hardware and software or in hardware alone. Examples of hardware include computing or processing systems, including personal computers, servers, laptops, mainframes, micro-processors and the like. Additionally, although aspects of the disclosed embodiments are described as being stored in memory, one skilled in the art will appreciate that these aspects can also be stored on other types of computer readable media, such as secondary storage devices, for example, hard disks, floppy disks, or CD ROM, or other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets. One or more of such software sections or modules can be integrated into a computer system or existing e-mail or browser software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed processes may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented method for providing a conditional credit line offer, comprising:
receiving a payment authorization request;
parsing, via a processor, the payment authorization request to extract payment information;
determining that the payment information includes information related to an extra credit line;
generating, via the processor, a credit-risk allocation notification associated with the extra credit line; and
transmitting the credit-risk allocation notification to a computer associated with a financial institution.

2. The method of claim 1, further comprising:
determining that a customer lacks sufficient funds to complete a purchase transaction;
generating an extra credit offer related to the extra credit line; and
transmitting the extra credit offer to a customer device.

3. The method of claim 2, wherein a value of the extra credit line equals or exceeds a value of funds that the customer lacks to complete the purchase transaction.

4. The method of claim 2, wherein the extra credit offer includes an indication of an annual percentage interest rate.

5. The method of claim 1, wherein the credit-risk allocation notification includes an amount payable by the financial institution.

6. The method of claim 5, wherein the credit-risk allocation notification includes a notification that the amount payable is conditioned on:
a purchase transaction associated with the payment authorization request being fraudulent; or
a customer defaulting on repayment associated with the extra credit line.

7. The method of claim 5, wherein the credit-risk allocation notification includes a notification that the amount payable is refundable, conditioned upon:
a purchase transaction associated with the payment authorization request being fraudulent; or
a customer defaulting on repayment associated with the extra credit line.

8. The method of claim 1, further comprising:
initiating a real-time bidding auction to determine an allocation associated with the credit-risk allocation notification.

9. A system, comprising:
a processor; and
a memory device storing instructions executable by the processor to:
receive a payment authorization request;
parse the payment authorization request to extract payment information;
determine that the payment information includes information related to an extra credit line;
generate a credit-risk allocation notification associated with the extra credit line; and
transmit the generated credit-risk allocation notification to a computer associated with a financial institution.

10. The system of claim 9, the memory device further storing instructions to:
determine that a customer lacks sufficient funds to complete a purchase transaction;
generate an extra credit offer related to the extra credit line; and
transmit the extra credit offer to a customer device.

11. The system of claim 10, wherein a value of the extra credit line equals or exceeds a value of funds that the customer lacks to complete the purchase transaction.

12. The system of claim 10, wherein the extra credit offer includes an indication of an annual percentage interest rate.

13. The system of claim 9, wherein the credit-risk allocation notification includes an amount payable by the financial institution.

14. The system of claim 13, wherein the credit-risk allocation notification includes a notification that the amount payable is conditioned on:
a purchase transaction associated with the payment authorization request being fraudulent; or
a customer defaulting on repayment associated with the extra credit line.

15. The system of claim 13, wherein the credit-risk allocation notification includes a notification that the amount payable is refundable, conditioned upon:
a purchase transaction associated with the payment authorization request being fraudulent; or
a customer defaulting on repayment associated with the extra credit line.

16. The system of claim 9, the memory device further storing instructions to:
initiate a real-time bidding auction to determine an allocation associated with the credit-risk allocation notification.

17. A non-transitory computer-readable medium storing instructions, the instructions executable by at least one processor to:
receive a payment authorization request;
parse the payment authorization request to extract payment information;
determine that the payment information includes information related to an extra credit line;
generate a credit-risk allocation notification associated with the extra credit line; and
transmit the generated credit-risk allocation notification to a computer associated with a financial institution.

18. The medium of claim 17, further storing instructions to:
determine that a customer lacks sufficient funds to complete a purchase transaction;
generate an extra credit offer related to the extra credit line; and
transmit the extra credit offer to a customer device.

19. The medium of claim 18, wherein a value of the extra credit line equals or exceeds a value of funds that the customer lacks to complete the purchase transaction.

20. The medium of claim 18, wherein the extra credit offer includes an indication of an annual percentage interest rate.

21. The medium of claim 17, wherein the credit-risk allocation notification includes an amount payable by the financial institution.

22. The medium of claim 21, wherein the credit-risk allocation notification includes a notification that the amount payable is conditioned on:
a purchase transaction associated with the payment authorization request being fraudulent; or
a customer defaulting on repayment associated with the extra credit line.

23. The medium of claim 21, wherein the credit-risk allocation notification includes a notification that the amount payable is refundable, conditioned upon:
a purchase transaction associated with the payment authorization request being fraudulent; or
a customer defaulting on repayment associated with the extra credit line.

24. The medium of claim 17, further storing instructions to:
initiate a real-time bidding auction to determine an allocation associated with the credit-risk allocation notification.
